(19) United States
(12) Patent Application Publication
(10) Pub. No.: US 2003/0035285 A1
(43) Pub. Date: Feb. 20, 2003

(54) Lighting fixure having fixation function

(76) Inventor: Tony Huang, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/930,210

(22) Filed: Aug. 16, 2001

(51) Int. Cl. F21V 21/088

(52) U.S. Cl. 362/191; 362/396; 362/190

(57) ABSTRACT

A lighting fixture comprises an LED lighting portion which is a metal housing and is provided at one end with a mirror and in the interior with batteries and an LED. The lighting fixture further comprises an adjustment locating portion and a fixation portion. The adjustment locating portion can be twisted, bent, and located. The adjustment portion is fastened with other end of the LED lighting portion. The fixation portion is fastened with other end of the adjustment locating portion and is provided with a clamping end for fixing the lighting fixture on an object.

### FIELD OF THE INVENTION

The present invention relates generally to a portable lighting fixture, and more particularly to a lighting fixture having a fixation function.

### BACKGROUND OF THE INVENTION

The portable lighting fixture, such as a flashlight, has a short service life span due to the limited service life spans of battery and light bulb. In addition, the portable lighting fixture is not resistant to impact. The lighting fixture, which is externally connected to the power source, is not limited by power. However, in light of the wiring limitation, it lacks mobility.

### SUMMARY OF THE INVENTION

The primary objective of the present invention is to provide a lighting fixture which is battery-powered, small in volume and portable, and has a relatively long service life span and a fixation function.

The foregoing objective of the present invention is attained by a lighting fixture comprising an LED lighting portion in which the battery and LED are disposed. The battery serves to provide LED with power. The lighting fixture further comprises an adjustment locating portion capable of being twisted, bent and located. The adjustment locating portion is connected with other end of the LED lighting portion. The adjustment locating portion is connected at other end with a fixation portion which has a clamping end capable of fixing the lighting fixture on an object.

The function and the feature of the present invention are further described in detail by two embodiments with reference to the accompanying drawings.

### BRIEF DESCRIPTION OF THE DRAWINGS

FIG. 1 shows an exploded view of a first preferred embodiment of the present invention.

FIG. 2 shows a perspective view of the first preferred embodiment of the present invention in combination.

FIG. 3 shows a perspective view of a second preferred embodiment of the present invention in combination.

### DETAILED DESCRIPTION OF THE INVENTION

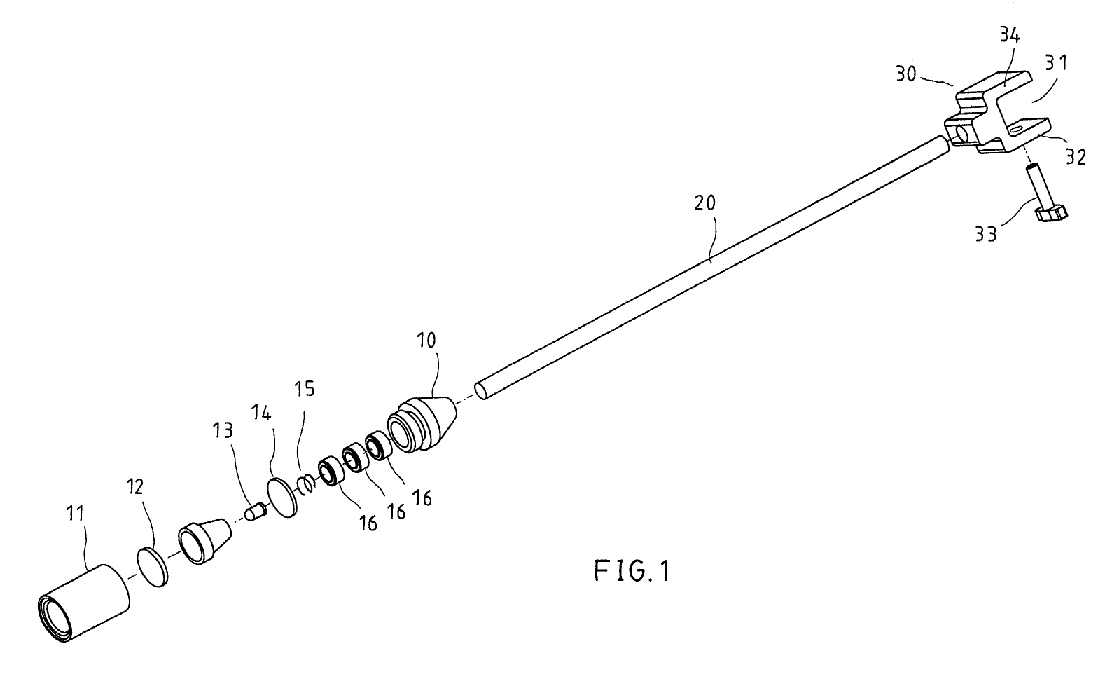

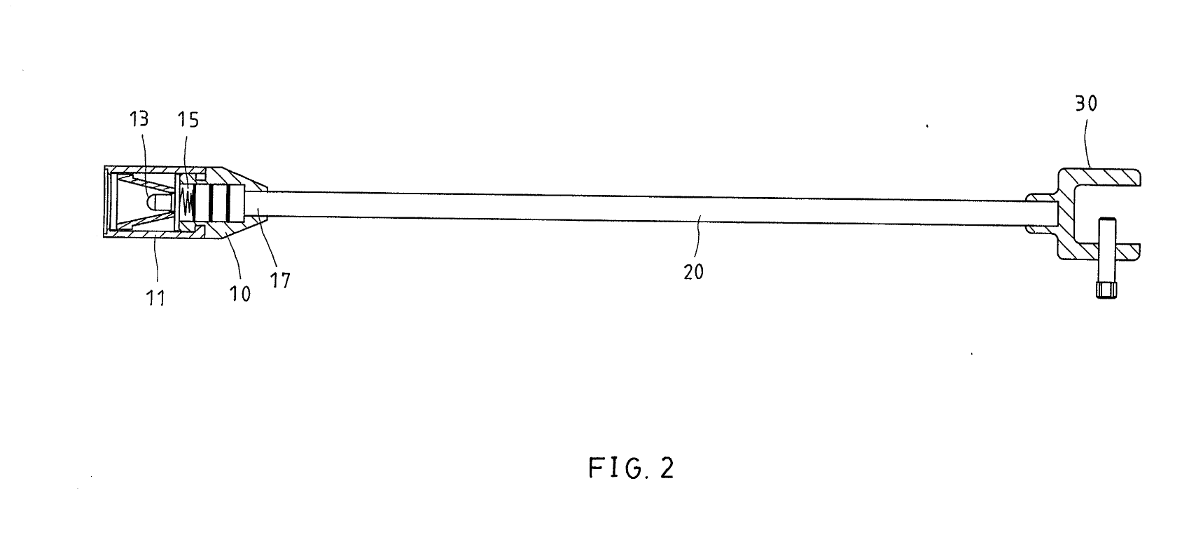

As shown in FIGS. 1 and 2, a lighting fixture of the present invention comprises an LED lighting portion 10, an adjustment locating portion 20, and a fixation portion 30.

The LED lighting portion 10 is a housing which is made of any material, such as a metal material of the first preferred embodiment of the present invention. The housing is provided at one end with a shade 11 which is in turn provided with a mirror 12. The shade is provided in the rear with a light-emitting diode (LED) 13 and a circuit board 14. The LED of the first preferred embodiment of the present invention is an LED capable of emitting white light. The circuit board is provided in the rear end with a spring 15. The housing is provided in the interior with batteries 16 which are serially connected. The first preferred embodiment of the present invention comprises three mercury batteries. The circuit is connected by the pressure which is brought about by the tightening of the shade and the housing. The power of batteries enables LED to illuminate toward the shade end of the LED lighting portion. The housing is provided at other end with a recessed mouth 17.

The adjustment locating portion 20 is a long tubular body made of a soft material and is provided in the interior with at least one pliable metal wire capable of being twisted, bent and located. The embodiment of the present invention uses a copper shaft cable. The adjustment locating portion is fixed in the recessed mouth 17 of the LED lighting portion 10 by an adhesive.

The fixation portion 30 is connected with other end of the adjustment locating portion 20 and is provided with a clamping end 31 for fixing the lighting fixture on an object. The clamping end of the first preferred embodiment of the present invention is a C-shaped clamp, as shown in FIG. 2. The C-shaped clamp has a C-shaped clamp board which is provided in one side wall 32 with a bolt 33. The bolt 33 is turned toward other side wall 34 so as to fix the lighting fixture.

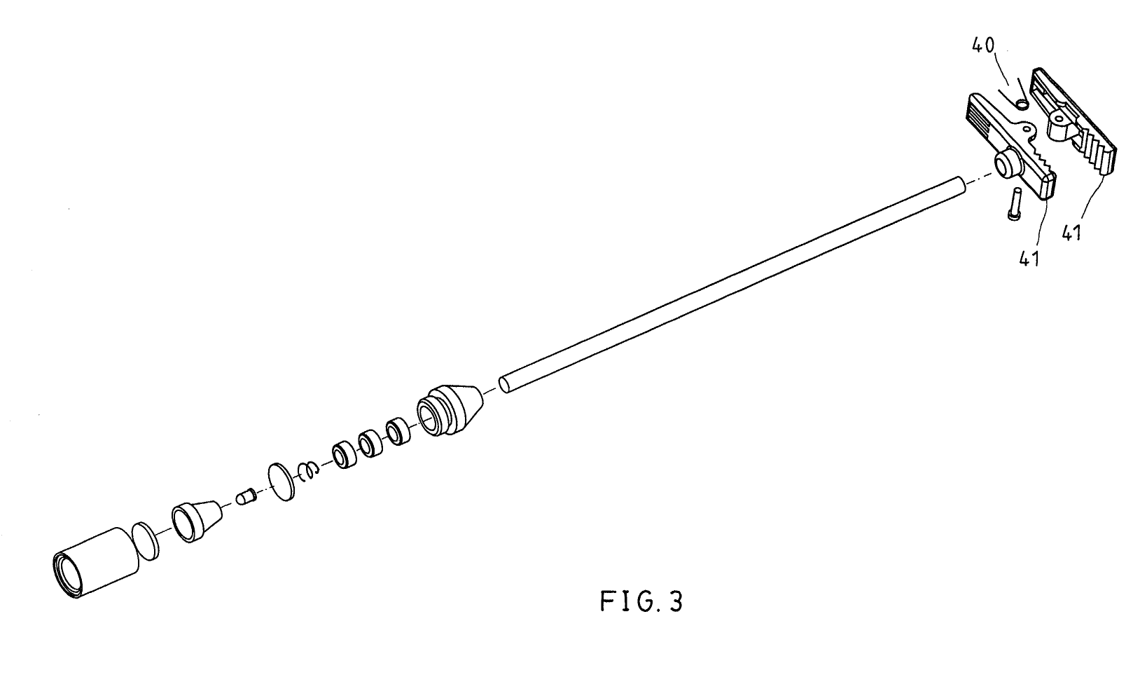

The clamping end of the second preferred embodiment is a clamping tool 40, as shown in FIG. 3, which is provided with two movable jaws 41 for clamping the object so as to fix the lighting fixture.

In use, the shade is fastened onto the metal housing to form the circuit so as to enable LED to illuminate. In light of LED being small in volume and light in weight, the present invention is portable and energy-efficient, thereby resulting in the prolongation of service life span. In addition, the present invention has a clamping function which enables the present invention to be fixed in any position. In light of the present invention being small in volume and flexible, the present invention is suitable for use in lighting a small narrow area, such as the area under the auto seat, etc., for finding a lost article or doing a repair work.

What is claimed is:

1. A lighting fixture comprising:
an LED lighting portion which is a housing, said housing being provided at one end with a transparent mirror and in the interior with batteries and LED, said LED making use of power of batteries to illuminate toward the mirror end;
an adjustment locating portion which is a long tubular body of a soft material and is provided in the interior with a flexible metal wire, said adjustment locating portion being fastened with other end of said LED lighting portion;
a fixation portion connected with other end of said adjustment locating portion and provided with a clamping end for fixing the lighting fixture on an object.

2. The lighting fixture as defined in claim 1, wherein said LED lighting portion comprises a shade which is disposed at one end of said housing and is provided with said transparent mirror.

3. The lighting fixture as defined in claim 1, wherein said adjustment locating portion is a copper shaft cable.

4. The lighting fixture as defined in claim 1, wherein said fixation portion is a C-shaped clamp.

5. The lighting fixture as defined in claim 1, wherein said fixation portion is a clamping tool having two movable jaws for fixing the lighting fixture on an object.
